(19) United States
(12) Patent Application Publication
(10) Pub. No.: US 2024/0323288 A1
(43) Pub. Date: Sep. 26, 2024

(54) IMAGE FORMING APPARATUS

(71) Applicant: CANON KABUSHIKI KAISHA, Tokyo (JP)

(72) Inventor: SHIGERU KAWASAKI, Kanagawa (JP)

(21) Appl. No.: 18/613,002

(22) Filed: Mar. 21, 2024

(30) Foreign Application Priority Data
Mar. 23, 2023 (JP) 2023-046750

(51) Int. Cl. H04N 1/00

(52) U.S. Cl. CPC H04N 1/00535; H04N 1/00557; H04N 1/00604

(57) ABSTRACT

A technique that can appropriately read an image of a document even if vibration caused by image formation occurs at the time of reading the image is to be provided. A reading part, which is configured with an image sensor capable of reading an image of a placed document while moving in a first direction with respect to the document, and an image forming part, which is configured with a print head that forms an image on a sheet conveyed in the first direction while moving in a second direction intersecting the first direction based on input data or data read by the reading part, are included.

### BACKGROUND OF THE INVENTION

### Field of the Invention

The present invention relates to an image forming apparatus capable of reading an image of a document and forming an image on a sheet.

### Description of the Related Art

Japanese Patent Laid-Open No. 2022-125811 discloses a technique related to an image forming apparatus equipped with an image reading part, which reads an image of a document, above an image forming part, which forms an image on a sheet. In the image forming apparatus disclosed in Japanese Patent Laid-Open No. 2022-125811, an automatic document conveyance part that automatically conveys a document as the image reading part reads the document is installed. In the image forming apparatus of Japanese Patent Laid-Open No. 2022-125811, if the surface from which the sheets on which an image has been formed are discharged is arranged so as to face the front of the user, an ADF conveys documents in the left-right direction.

However, if the image forming apparatus of Japanese Patent Laid-Open No. 2022-125811 is placed in a narrow space such as under a shelf or a desk so that the discharge surface of the sheets on which an image has been formed faces the front of the user, the left-right space for the conveyance of documents would be narrow. For this reason, it has been difficult to perform jobs such as setting documents in the ADF, taking out discharged documents, and the like, which results in deterioration in operability for the user.

### SUMMARY OF THE INVENTION

The present invention has been made in view of the above-mentioned problems, and provides a technique that can suppress the deterioration in operability for the user even with installation in a narrow space.

In the first aspect of the present invention, there is provided an image forming apparatus including:
a reading part configured with an image sensor capable of reading an image of a placed document while moving in a first direction with respect to the document; and
an image forming part configured with a print head that forms an image on a sheet conveyed in the first direction while moving in a second direction intersecting the first direction, based on input data or data read by the reading part.

According to the present invention, it is possible to suppress deterioration in operability for the user even with installation in a narrow space.

Further features of the present invention will become apparent from the following description of exemplary embodiments with reference to the attached drawings.

### BRIEF DESCRIPTION OF THE DRAWINGS

FIG. 1A and FIG. 1B are external views of an image forming apparatus;

FIG. 2A and FIG. 2B are schematic configuration diagrams of an image forming part;

FIG. 3A and FIG. 3B are schematic configuration diagrams of an image reading part;

FIG. 4A and FIG. 4B are exploded configuration diagrams of a reading carriage unit;

FIG. 5A and FIG. 5B are cross-sectional views of the image forming apparatus;

FIG. 6A and FIG. 6B are cross-sectional views of the image forming apparatus;

FIG. 7 is a diagram illustrating the positional relationship of the main configurations of the image forming part and the image reading part;

FIG. 8 is a cross-sectional view of an ADF and its vicinity;

FIG. 9A and FIG. 9B are diagrams illustrating forms of a document feeding tray at a second position;

FIG. 10 is a right side view of the image forming apparatus;

FIG. 11 is a diagram illustrating the positional relationship between the document conveyance center N1 and the center position N2 of the apparatus;

FIG. 12 is a diagram schematically illustrating movement mechanisms of the image forming part and the image reading part;

FIG. 13A and FIG. 13B are external views of an image forming apparatus according to a known technique as a comparative example; and

FIG. 14 is a diagram illustrating an opened state of the image reading part.

### DESCRIPTION OF THE EMBODIMENTS

Hereinafter, with reference to the accompanying drawings, an explanation is given of an example of an embodiment of an image forming apparatus. Note that the following embodiment is not intended to limit the present invention, and every combination of the characteristics explained in the present embodiment is not necessarily essential to the solution provided in the present invention. Further, the positions, shapes, etc., of the constituent elements described in the embodiment are merely examples and are not intended to limit this invention to the examples.

### (Overall Configuration of Image Forming Apparatus)

In the present embodiment, an image forming apparatus that can read an image of a document conveyed by an automatic document conveyance apparatus (hereinafter referred to as an “ADF (Automatic Document Feeder)”) and form an image on a sheet is taken as an example for the explanation. Note that, in the following explanation, “reading an image of a document” may also be expressed simply as “reading a document.” The techniques disclosed in the present embodiment are not limited to the image forming apparatus explained below only, but can be applied to copiers, facsimiles, multifunction peripherals, or the like in which a flatbed scanner apparatus and an image forming apparatus are combined. In the present embodiment, a sheet includes any known medium, such as ordinary paper, special paper such as coated paper, a printing material with a special shape such as an envelope or index paper, a plastic film, and a cloth, on which an image can be formed with a liquid such as ink. Note that a document is also an example of a sheet.

The directions used in the present embodiment are expressed as the directions of the case where the user faces the image forming apparatus during use, and are expressed using the X direction, Y direction, and Z direction that are orthogonal to each other. Specifically, the X direction is the left-right direction, the Y direction is the front-back direction, and the Z direction is the up-down direction, and in the illustration in each drawing, the X direction is the direction from the left side toward the right side, the Y direction is the direction from the front side (the near side) toward the back side (the far side), and the Z direction is the direction from the lower side toward the upper side.

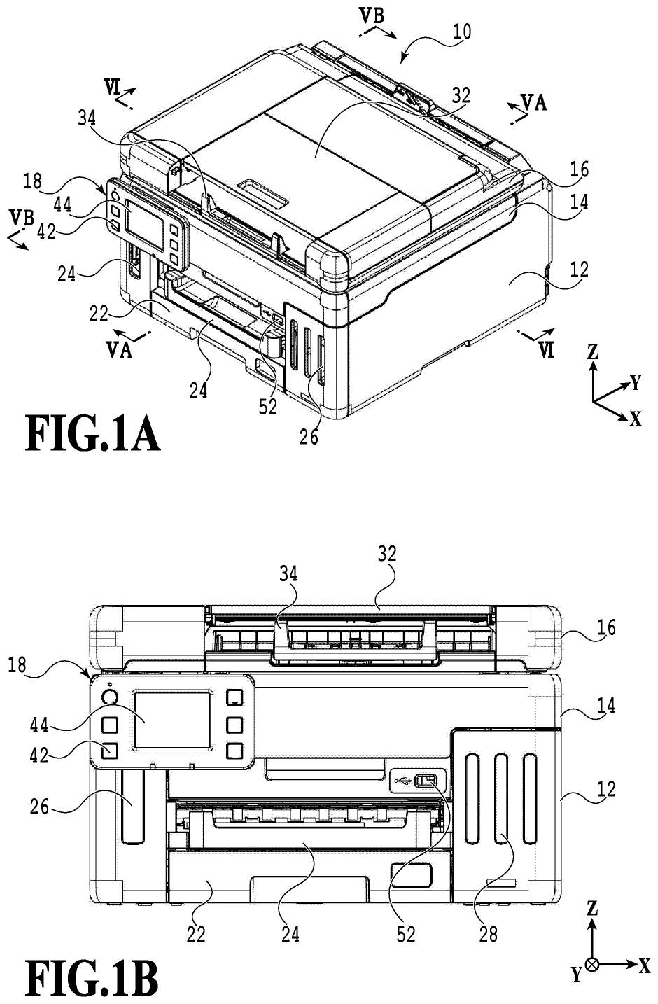

FIG. 1A and FIG. 1B are external views of the image forming apparatus. Further, FIG. 1A is a perspective view, and FIG. 1B is a front view. The image forming apparatus 10 includes the image forming part 12 that forms an image on a sheet, the image reading part 14 that can read an image of a document, and the ADF 16 that can convey the document whose image is to be read by the image reading part 14. In the image forming apparatus 10, the image reading part 14 is arranged above the image forming part 12, and the ADF 16 is arranged above the image reading part 14. That is, in the image forming apparatus 10, the image forming part 12, the image reading part 14, and the ADF 16 are arranged in this order in the Z direction. Further, the image forming apparatus 10 also includes the operation panel 18 on which user operations can be input and notifications of various information can be provided to the user. In the present embodiment, the operation panel 18 functions as an operation part that can operate the image forming apparatus 10.

The image forming part 12 includes the cassette 22 which accommodates sheets on which an image has not been formed and the discharge tray 24 which is arranged above the cassette 22 and to which sheets on which an image has been formed are discharged. The cassette 22 is removably arranged at the front (the front surface) of the image forming part 12 (the image forming apparatus 10). Further, as described in detail later, the discharge tray 24 is configured so that a part of its configuration can be drawn out to the front side.

In the present embodiment, each of the cassette 22 and the discharge tray 24 is arranged with its center position shifted to the left side of the center position of the image forming apparatus 10 in the X direction (the left-right direction), but there is not a limitation as such. That is, each of the cassette 22 and the discharge tray 24 may be arranged to be shifted to the right side depending on the sizes and arrangement positions of the other configurations. Alternatively, each of the cassette 22 and the discharge tray 24 may be arranged with its center position matching the center position of the image forming part 12.

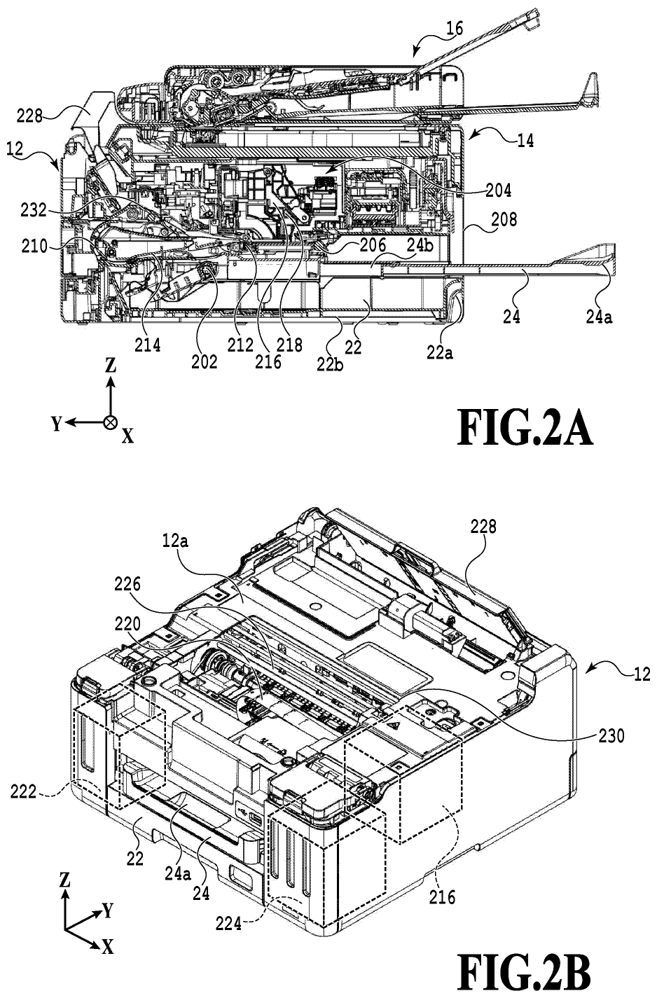

The image forming part 12 is equipped with the ink tanks 222 and 224 (see FIG. 2B) that store inks, which are printing agents, on both sides of the cassette 22 and the discharge tray 24 in the X direction, respectively. Furthermore, the image forming part 12 includes the remaining amount display parts 26 and 28, which display the remaining ink amounts in the respective ink tanks, at positions corresponding to the respective ink tanks on the front side. The remaining amount display parts 26 and 28 may be windows through which the remaining ink amounts in the corresponding ink tanks can be visually checked, or may be display screens that display images corresponding to the remaining amounts. A configuration in which the arrangement of the ink tanks 222 and 224 is inverted with respect to the left and right sides or a configuration in which the ink tanks 222 and 224 are arranged together on the right side or the left side is also possible.

In the present embodiment, since the image forming apparatus 10 is capable of forming a full-color image, black ink is stored in the ink tank 222 located on the left side. Further, in the ink tank 224 located on the right side, cyan ink, magenta ink, and yellow ink are individually stored. Therefore, the remaining amount display part 26 displays the remaining amount of black ink, and the remaining amount display part 28 displays the remaining amounts of cyan ink, magenta ink, and yellow ink. Although the present embodiment has the configuration using the four types of ink, but there is not a limitation as such, and a configuration using one to three types or five or more types of ink and a configuration using processing liquid for performing a predetermined process on the ink ejected on a sheet are also possible. Further, in the present embodiment, the ink tanks 222 and 224 function as storage parts that store printing agents such as ink and processing liquid.

The image forming part 12 is equipped with a USB (Universal Serial Bus) terminal 52 that can be connected to an external terminal such as a personal computer. In the present embodiment, it is installed on the front surface of the image forming part 12 in order to improve the operability for the user. Note that the USB terminal 52 may be installed on a side surface (the right side, the left side) or the rear surface (the back surface) of the image forming part 12.

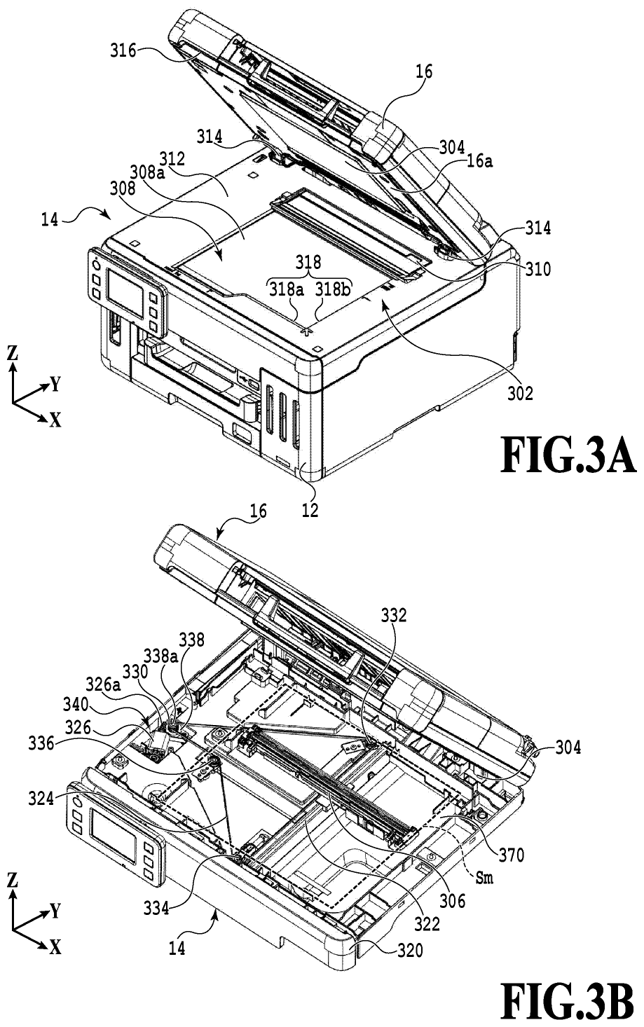

The image reading part 14 includes the reading carriage unit 306 (see FIG. 3A and FIG. 3B) that reads the images of a document conveyed by the ADF 16 and a document placed on the document table glass 308 (hereinafter described). The ADF 16 includes the document feeding tray 32 on which a document whose image is to be read is placed and the document discharge tray 34 from which a document whose image has been read is discharged. Each of the document feeding tray 32 and the document discharge tray 34 is installed with its center position in the X direction shifted to the right side relative to the center position of the image reading part 14 (the image forming apparatus 10).

The operation panel 18 is arranged on the left side of the front surface of the image forming apparatus 10 as well as at a height position where the image reading part 14 is arranged. In the present embodiment, the operation panel 18 is arranged at a position where the left side surface of the operation panel 18 and the left side surface of the image forming apparatus 10 substantially match in the X direction. Note that the operation panel 18 may be arranged on the right side of the front surface of the image forming apparatus 10. That is, it is sufficient as long as the operation panel 18 is arranged on the left side or the right side so as not to protrude from the image forming apparatus 10 in the X direction. The operation panel 18 includes the physical switch 42 such as a start button and the display part 44 such as a touch panel capable of displaying various types of information and allowing input by touch operations.

### (Configuration of Image Forming Part)

Next, with reference to FIG. 2A and FIG. 2B, a detailed explanation is given of the configuration of the image forming part 12. FIG. 2A and FIG. 2B are diagrams for explaining the configuration of the image forming part 12. Further, FIG. 2A is a cross-sectional view of the image forming apparatus 10 at substantially the center position in the X direction, and FIG. 2B is a perspective view of the image forming part 12. Note that, in the illustration in FIG. 2A, the document feeding tray 32, the document discharge tray 34, and the discharge tray 24 are in the states of being drawn out. Further, in FIG. 2B, illustration of the image reading part 14 and ADF 16 is omitted for ease of understanding.

The image forming part 12 includes the pickup roller 202 that feeds a sheet accommodated in the cassette 22, and the printing part 204 that performs printing by ejecting ink onto the sheet fed and transported by the pickup roller 202 to form an image on the sheet. Further, the image forming part 12 includes the discharge roller 206 that discharges the sheet on which an image has been formed by the printing part 204 to the discharge tray 24 (see FIG. 2A).

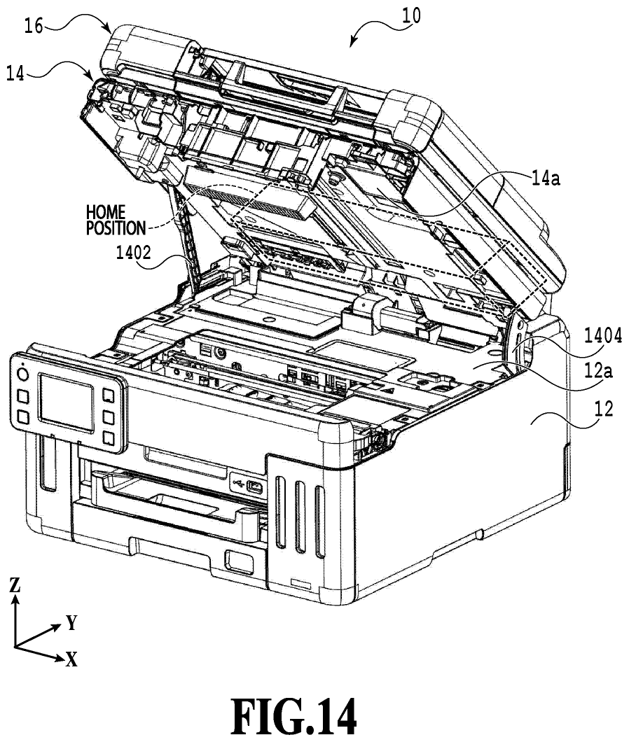

In the image forming part 12, the opening part 230 is formed on the upper surface 12a at a position corresponding to the printing part 204 (see FIG. 2B). Further, the image reading part 14 is arranged so as to be openable on the back side of the upper surface 12a of the image forming part 12. Therefore, in the image forming apparatus 10, the image reading part 14 is brought into a closed state at the time of performing printing with the image forming part 12, at the time of reading a document with the image reading part 14, or the like (see FIG. 1A). Further, in the image forming part 12 of the image forming apparatus 10, in a case where accessing to the printing part 204 is required or the like, the image reading part 14 is brought into an opened state (see FIG. 14).

The cassette 22 accommodates multiple sheets stacked therein. The cassette 22 is configured to be insertable and removable to/from the housing 208 of the image forming part 12. For accommodating sheets in the cassette 22, the user grasps the grip part 22a provided on the front surface of the cassette 22 and draws out the cassette 22 to the front side. Then, after accommodating multiple sheets in a stacked state in the cassette 22, the cassette 22 is inserted to the accommodation part 22b formed in the housing 208. Thereafter, the cassette 22 is pushed to the back side, so that the cassette 22 is inserted to the housing 208.

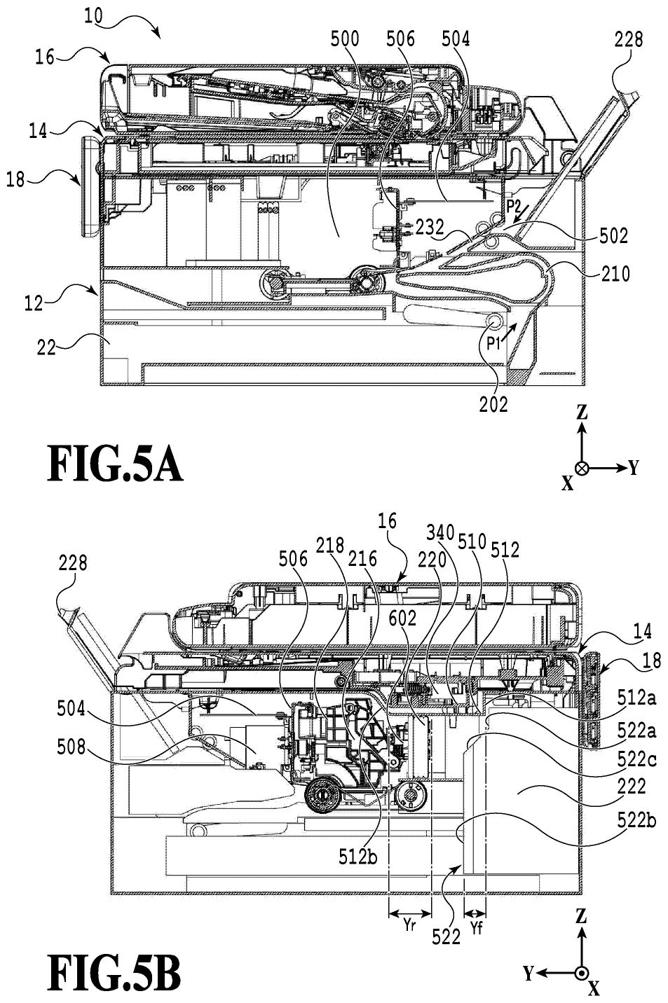

The pickup roller 202 feeds the uppermost sheet of the sheets stacked in the cassette 22 inserted into the housing 208 to the printing part 204. Specifically, the sheet fed by the pickup roller 202 reaches the registration roller pair 212 via the conveyance path 210. The conveyance path 210 is formed in a substantially U-shape, so that the sheet fed from the front side toward the back side is made to make a U-turn at the curved portion and guided from the back side toward the front side up to the registration roller pair 212. Further, the image forming part 12 includes the manual feed tray 228. Sheets placed on the manual feed tray 228 are transported by the ASF (Auto Sheet Feeder) 502 (see FIG. 5A). A sheet transported by the ASF 502 reaches the registration roller pair 212 via the conveyance path 232. The sheet transported via the conveyance paths 210 and 232 abuts on the registration roller pair 212 whose rotation is stopped. Accordingly, the skew of the transported sheet is corrected. The registration roller pair 212 is rotated in accordance with the timing of image formation, and conveys the sheet to the printing part 204.

Note that, on the upstream side of the sheet conveyance direction of the registration roller pair 212, the reverse conveyance path 214 is installed to reverse the sheet conveyed in the direction opposite to the conveyance direction and transport the sheet to the printing part 204. In a case of forming images on both sides of a sheet, first, the printing part 204 forms an image on one surface of the sheet conveyed in the conveyance direction (the direction from the back side toward the front side) from the conveyance path 210. Next, while conveying the sheet with the image formed on one surface in the direction opposite to the conveyance direction, the conveyance path is switched by a switching member (not illustrated in the drawing), so that the sheet is guided to the reverse conveyance path 214. Then, the sheet reversed by the reverse conveyance path 214 reaches the registration roller pair 212 again, and the printing part 204 forms an image on the other surface of the sheet.

The printing part 204 includes the print head 216 that can eject ink by an inkjet system. The print head 216 is installed corresponding to the type of ink, and performs printing by ejecting ink to the sheet conveyed via the registration roller pair 212 according to an image signal read by the image reading part 14 or an image signal input from an external terminal. Accordingly, an image is formed on the sheet.

The printing part 204 includes the printing carriage unit 218 on which the print head 216 is mounted and which is configured to be movable in the X direction. The printing carriage unit 218 is connected to the ink tanks 222 and 224 via the tube 220, and the inks stored in the ink tanks 222 and 224 are supplied via the tube 220. The ink supplied to the printing carriage unit 218 is supplied to the print head 216. Note that the tube 220 is installed individually for each type of ink although the illustration in FIG. 2B is simplified. The printing carriage unit 218 is installed so as to be slidable on the guide rail 226 that extends in the direction intersecting the conveyance direction (the Y direction) (in the present embodiment, extends in the X direction orthogonally intersecting the conveyance direction) of the sheet conveyed by the registration roller pair 212. The printing carriage unit 218 is configured to be reciprocally movable in the X direction along the guide rail 226 by the driving of the drive motor 508 (see FIG. 5B).

In the image forming part 12, after a conveyance operation in which the registration roller pair 212 conveys a sheet by a predetermined amount in the Y direction, a printing operation in which inks are ejected from the print head 216 to the sheet while the printing carriage unit 218 moves in the X direction is performed. Thereafter, the conveyance operation is executed again, and then the printing operation is executed. In this way, in the image forming part 12, by alternately and repeatedly executing the conveyance operation and the printing operation under the control with the control circuit board 504 (see FIG. 5A), an image is formed on a sheet based on image data.

Note that the printing carriage unit 218 is equipped with a sensor (not illustrated in the drawings) that detects an end of a sheet. In the image forming part 12, the size of a sheet, the relative positions of the sheet and the print head 216, the timing to start printing on the sheet, etc., are determined by the control circuit board 504 based on a detection result provided by this sensor.

The discharge roller 206 discharges the sheet in a direction from the back side toward the front side. The handle part 24a which has an opening on its upper surface and onto which the user can put his or her hand is formed near the front end of the discharge tray 24. If the user puts his or her hand and draws the handle part 24a to the front side, the discharge tray 24 is drawn out to the front side. If the discharge tray 24 drawn out from the housing 208 is pressed to the back side by the user, the discharge tray 24 is accommodated in the accommodation part 24b which is installed in the housing 208.

### (Configuration of Image Reading Part)

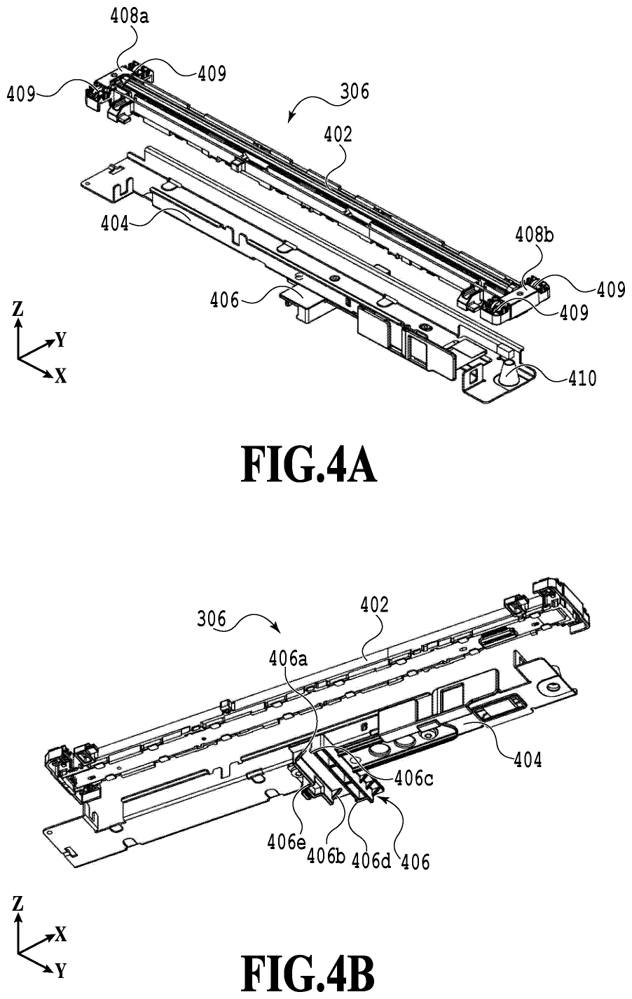

Next, with reference to FIG. 3A to FIG. 4B, a detailed explanation is given of the configuration of the image reading part 14. FIG. 3A and FIG. 3B are diagrams for explaining the configuration of the image reading part 14. Further, FIG. 3A is a perspective view of the image forming apparatus 10 with the ADF 16 being in an opened state, and FIG. 3B is a diagram illustrating the internal configuration of the image reading part 14. Note that FIG. 3B illustrates a state in which the document table is removed from the image reading part 14. FIG. 4A and FIG. 4B are partially exploded configuration diagrams of the reading carriage unit. Further, FIG. 4A is a perspective view seen from above, and FIG. 4B is a perspective view seen from below.

The image reading part 14 includes the document table 302 on which a document to be read can be placed, the pressure plate part 304 that presses the document placed on the document table 302, and the reading carriage unit 306 that reads the image of the document via the document table 302.

### <Document Table and Pressure Plate Part>

The document table 302 includes the document table glass 308, on which a document is placed so that the surface on which the image to be read is drawn is in contact with the document table glass 308, and the ADF glass 310, above which the surface on which the image of the document conveyed by the ADF 16 passes. The document table glass 308 and the ADF glass 310 are each made of a colorless and transparent glass, and are arranged side by side in the Y direction in the frame member 312. In the document table 302, the frame member 312, the document table glass 308, and the ADF glass 310 have upper surfaces located on substantially the same plane.

The pair of hinge parts 314 with pivot axes parallel to the X direction are installed on the back side of the frame member 312, and the ADF 16 is arranged above the frame member 312 in a manner capable of pivotal movement via the hinge parts 314. Therefore, for placing a document on the document table glass 308, the ADF 16 is brought into the opened state (see FIG. 3A), so that the document table glass 308 is exposed to the outside. Further, for reading the document on the document table glass 308, the ADF 16 is brought into the closed state (see FIG. 1A). If the ADF 16 is in the closed state, the bottom surface 16a of the ADF 16 is positioned on the document table 302. For this reason, the pressure plate part 304 is arranged at a predetermined position on the bottom surface 16a, which includes an area that faces the document table glass 308 while the ADF 16 is in the closed state. Accordingly, by closing the ADF 16, the document placed on the document table glass 308 is pressed by the pressure plate part 304. Note that the lower side of the front surface of the ADF 16 has the notch part 316 into which the user can insert his or her fingers to grasp the ADF 16 for opening and closing the ADF 16.

In the present embodiment, the image reading part 14 can execute what is termed as a continuous reading mode in which, while the ADF 16 conveys documents, the reading carriage unit 306 located at the reading position reads the images of the documents. Further, the image reading part 14 can execute what is termed as a fixed reading mode in which, in a state where a document placed on the document table glass 308 is pressed against the document table glass 308 by the pressure plate part 304, the image of the document is read as the reading carriage unit 306 moves. In the present embodiment, the ADF 16 functions as a conveyance part that conveys documents to be read by the reading carriage unit 306.

Note that the maximum size of a document whose image can be read may be different or the same in the continuous reading mode and the fixed reading mode. If the maximum sizes are different, for example, the maximum size of the document whose image can be read is made smaller in the fixed reading mode than in the continuous reading mode. Specifically, for example, the maximum document size in the continuous reading mode is A4 size, and the maximum document size in the fixed reading mode is A5 size.

The upper surface of the document table glass 308 serves as the document placement surface 308a on which a document is placed. Further, the document table glass 308 is equipped with the abutting part 318 against which an edge of a document can be abutted in order to position the document to be placed. The abutting part 318 includes the first abutting part 318a extending in the X direction and the second abutting part 318b extending in the Y direction. Accordingly, in the abutting part 318, the first abutting part 318a is to position the document in the front-back direction (Y direction), and the second abutting part 318b is to position the document in the left-right direction (X direction).

In a case of reading a document in the fixed reading mode, the image drawn on the document surface that is in contact with the document placement surface 308a is read by the reading carriage unit 306 which is arranged on the lower surface side of the document table glass 308. At this time, the reading carriage unit 306 needs to read the entire area of the reading surface of the document (the surface on which the image is drawn that is in contact with the document placement surface 308a) while moving in the Y direction. For this reason, the document table glass 308 is designed to a size that allows reading of the entire area of the readable maximum document size.

The ADF glass 310 is arranged on the back side of the document table glass 308 in the Y direction. The arrangement position of the ADF 310 corresponds to the reading position where the reading carriage unit 306 is located in the continuous reading mode. That is, in a case of performing the continuous reading mode, the reading carriage unit 306 moves to the reading position where the ADF glass 310 is located on the upper side, and at this reading position, the image of the document being conveyed by the ADF 16 and passing over the ADF glass 310 is read. In this way, in the present embodiment, the document table glass 308 functions as a reading area where a document is placed on one surface and the reading carriage unit 306 moves on the other surface. Further, the ADF glass 310 functions as a reading area where the document conveyed by the ADF 16 passes on one surface and the reading carriage unit 306 remains on the other surface.

### <Reading Carriage Unit>

The reading carriage unit 306 includes the image sensor 402 for reading an image of a document, the sensor holder 404 for holding the image sensor 402, and the slider 406 installed substantially at the center of the lower surface 404a of the sensor holder 404 (see FIG. 4A). Further, the reading carriage unit 306 includes the roller units 408a and 408b at both ends of the image sensor 402 in its extending direction, so as to ensure the focal length to the document via the document table glass 308. Two rollers 409 are arranged side by side in each of the roller units 408a and 408b in a direction intersecting (orthogonally in the present embodiment) the extending direction of the reading carriage unit 306. Each of the rollers 409 is installed so that its rotation axis is parallel to the extending direction.

Furthermore, the reading carriage unit 306 includes the pressing spring 410 between the image sensor 402 and the sensor holder 404. The pressing spring 410 arranged in the image reading part 14 presses the image sensor 402 upward and also presses the sensor holder 404 downward. The four sliding surfaces 406a, 406b, 406c, and 406d are formed on the slider 406 (see FIG. 4B). The slider 406 is arranged so that these sliding surfaces slide on the later-described rail part 322 (see FIG. 3B). Thereby, the reading carriage unit 306 is configured to be able to move smoothly along the rail part 322 via the slider 406. Further, the slider 406 is formed with the fixing part 406e to which the belt 324 (see FIG. 3B) that operates via the driving of the later-described drive motor 326 (see FIG. 3B) is fixed. In the present embodiment, the slider 406 functions as a sliding part that can slide on the rail part 322, and the pressing spring 410 functions as a pressing part that presses the sensor holder 404, on which the slider 406 is installed, against the rail part 322.

As the image sensor 402, for example, a contact image sensor (CIS) is used. The CIS irradiates light from a light source such as an LED (Light Emitting Diode) to the document surface on which an image is drawn, and images the reflected light from the surface onto a sensor element using a self-focusing rod lens array, thereby reading the image. The image sensor 402 is arranged so as to extend in the X direction.

The reading carriage unit 306 is arranged below the document table glass 308 and the ADF glass 310 so as to be movable in the Y direction. That is, in the present embodiment, the moving direction of the reading carriage unit 306 intersects (orthogonally in the present embodiment) the moving direction of the printing carriage unit 218 of the image forming part 12. The reading carriage unit 306 is moved to the reading position below the ADF glass 310 for the continuous reading mode (for reading a document conveyed by the ADF 16), and remains at the reading position to read an image. On the other hand, for the fixed reading mode, an image is read while moving in the Y direction below the document table glass 308 from the reading start position where reading of a document is started.

The reading carriage unit 306 is arranged so as to be able to reciprocate in the Y direction with the image sensor 402 extending in the X direction. Further, the reading carriage unit 306 is arranged inside the housing 320 of the image reading part 14 so as to be able to read the document on the document table glass 308 and the ADF glass 310. That is, the reading carriage unit 306 can reciprocate inside the image reading part 14 below the document table glass 308 and the ADF glass 310 so as to be able to read the document via the document table glass 308 and the ADF glass 310. Note that the image sensor 402 has a length in its extending direction (the X direction) capable of reading a range of the width direction length of an A4 size, for example.

### <Movement Mechanism of Reading Carriage Unit>

Inside the housing 320, the image reading part 14 includes a configuration for reciprocating the reading carriage unit 306 in the Y direction. Specifically, the image reading part 14 includes the rail part 322 extending in the Y direction, the belt 324 for moving the reading carriage unit 306 arranged on the rail part 322 in a slidable manner, and the drive motor 326 for operating the belt 324.

The slider 406 of the reading carriage unit 306 is arranged on the rail part 322 in a slidable manner. Further, in the slider 406, a part of the belt 324 is fixed to the fixing part 406e. Thereby, by transmitting the driving force of the drive motor 326 which is a driving source to the reading carriage unit 306 via the belt 324, the reading carriage unit 306 can reciprocate in the Y direction, which is the direction in which the rail part 322 extends.

In the present embodiment, the rail part 322 functions as a guide part that guides the movement of the reading carriage unit 306 in the Y direction. Further, the belt 324 functions as a transmission part that transmits the driving force generated by the drive motor 326 to the reading carriage unit 306. Furthermore, the drive motor 326 (the later-described drive unit 340) functions as a driving part for moving the reading carriage unit 306.

The drive motor 326 is installed outside the movement area Sm where the reading carriage unit 306 is positioned during its movement, i.e., on one side of the movement area Sm in the X direction. In the present embodiment, the drive motor 326 is installed on the left side of the movement area Sm. That is, in the present embodiment, the drive motor 326 is arranged at a position overlapping with the operation panel 18 in the X direction, i.e., on the back side of the operation panel 18. As described in detail later, in the present embodiment, the document conveyance center in the ADF 16 is shifted to the right side from the center position of the image reading part 14 (the image forming apparatus 10) in the X direction. Therefore, the center position of the movement area Sm is also shifted to the right side from the center position of the image reading part 14 in the X direction, and thus the image reading part 14 has a larger space on the left side than on the right side of the movement area Sm. Therefore, the drive motor 326 (the later-described drive unit 340) is installed in the relatively wide space on the left side. That is, with respect to the X direction, it is preferred that the drive motor 326 is installed on the opposite side of the side to which the document conveyance center in the ADF 16, i.e., the center position of the movement area Sm, is shifted from the center position of the image reading part 14.

The belt 324 is stretched around four pulleys, i.e., the drive pulley 330, the first pulley 332, the second pulley 334, and the third pulley 336. The reading carriage unit 306 is fixed to the belt 324 between the first pulley and the second pulley. Accordingly, with the belt 324 operated by the drive motor 326, the reading carriage unit 306 is configured to be able to reciprocate between the first pulley 332 and the second pulley 334.

The drive pulley 330 is a pulley which is arranged near the drive motor 326 and to which the driving of the drive motor 326 is transmitted. The drive pulley 330 is installed on the output shaft 338a of the decelerator 338 that decelerates the driving of the drive shaft 326a of the drive motor 326 for output. In the present embodiment, the drive unit 340 equipped with the drive motor 326, the drive pulley 330, and the decelerator 338 is installed outside the movement area Sm of the reading carriage unit 306, i.e., on the left side of the image reading part 14. In this way, by arranging the drive unit 340 outside the movement area Sm, i.e., on the left side of the image reading part 14, that is, in the space created by shifting from the document conveyance center and the center of the apparatus, an increase in size of the image reading part 14 in the X direction is suppressed.

The first pulley 332 is arranged on one side of the reading carriage unit 306 in the moving direction (the Y direction), more specifically, even on the back side compared to the back-side moving end of the reading carriage unit 306 (that is, compared to the back-side end of the movement area Sm). The ADF glass 310 is located on the back side of the document table glass 308. Therefore, the first pulley 332 is arranged on the back side of the reading position where the reading carriage unit 306 is located in the continuous reading mode. That is, the first pulley 332 is arranged at a position that allows the reading carriage unit 306 to be positioned at the reading position. Note that, if it is necessary to position the reading carriage unit 306 on the back side relative to the reading position, for example, for setting the home position on the back side relative to the reading position, the position of the first pulley 332 also moves in accordance with the position of the backmost end where the reading carriage unit 306 can be located. The home position of the reading carriage unit 306 is the position where the reading carriage unit 306 is located during a standby period or the like in which reading is not performed.

The second pulley 334 is arranged on the other side in the moving direction of the reading carriage unit 306, more specifically, even on the front side compared to the front-side moving end of the reading carriage unit 306 (that is, compared to the front-side end of the movement area Sm). If it is necessary to position the reading carriage unit 306 on the front side relative to the first abutting part 318a in the document table glass 308, the position of the second pulley 334 also moves in accordance with the position of the foremost end where the reading carriage unit 306 can be located. The first pulley 332 and the second pulley 334 are arranged so that the belt 324 located between the first pulley 332 and the second pulley 334 extends substantially in the Y direction.

The third pulley 336 is arranged between the first pulley 332 and second pulley 334 and the drive unit 340 in the X direction as well as between the first pulley 332 and the second pulley 334 in the Y direction. Note that, in FIG. 3B, the third pulley 336 is arranged so as to overlap with the movement area Sm in the XY plane, but there is not a limitation as such, and the third pulley 336 may be arranged so as not to overlap with the movement area Sm. The third pulley 336 is installed to increase the number of winding angles of the belt 324 so as to prevent tooth skipping in the driving of the belt 324 and the drive pulley 330. Such a configuration is effective in a case of rotating at high speed with large torque in order to improve productivity, for example.

In the present embodiment, the home position of the reading carriage unit 306 is set close to the back side of the reading carriage unit 306, for example, between the document table glass 308 and the ADF glass 310. Therefore, for reading a document in the fixed reading mode, the reading carriage unit 306 moves forward from the home position and then reads the document while moving toward the back side. Therefore, the front-side moving end of the reading carriage unit 306 is located on the front side, relative to a starting position where reading of a document starts, by an approach distance that allows the reading carriage unit 306 to move at a stable speed toward the back side from the starting position. Taking these points into consideration, the arrangement position of the second pulley 334 is determined. Note that the home position may be set on the front side of the document table glass 308 in the Y direction. In this case, the arrangement position of the second pulley 334 is determined in consideration of the space for the home position.

Note that, in the present embodiment, the drive unit 340 moves the reading carriage unit 306 from the front side toward the back side for reading a document placed on the document table glass 308 under the control of the control circuit board 504 (described later). Therefore, the first abutting part 318a for positioning the document placed on the document table glass 308 in the Y direction is located on the front side of the document table 302.

In this way, in the present embodiment, the drive unit 340 is located on the left side of the movement area Sm, the first pulley 332 is located on the back side of the movement area Sm, and the second pulley 334 is located on the front side of the movement area Sm. Therefore, the belt 324 is stretched and set in a substantially triangular shape. Further, the belt 324 is substantially parallel to the rail part 322 between the first pulley 332 and the second pulley 334 to which the reading carriage unit 306 is fixed. Therefore, by driving the drive motor 326 to operate the belt 324, the reading carriage unit 306 reciprocates between the first pulley 332 and the second pulley 334 along the rail part 322. Accordingly, the reading carriage unit 306 can be moved to the reading position in the continuous reading mode, and the reading carriage unit 306 can be moved in the Y direction in the fixed reading mode.

### (Configuration of Boundary Between Image Forming Part and Image Reading Part)

Next, with reference to FIG. 5A to FIG. 7, an explanation is given of the positional relationship of each configuration in the image forming part 12 and the image reading part 14. Further, an explanation is given of the shape of the boundary between the image forming part 12 and the image reading part 14, i.e., the upper surface 12a of the image forming part 12 and the bottom surface 14a of the image reading part 14 (see FIG. 14). FIG. 5A and FIG. 5B are cross-sectional views of the image forming apparatus 10. Further, FIG. 5A is a cross-sectional view taken along the line VA-VA in FIG. 1A, and FIG. 5B is a cross-sectional view taken along the line VB-VB in FIG. 1A. Note that, in FIG. 5A and FIG. 5B, the manual feed tray 228 is illustrated in an opened state. Further, in the illustration of FIG. 5A, some configurations including the printing carriage unit 218 are omitted for ease of understanding.

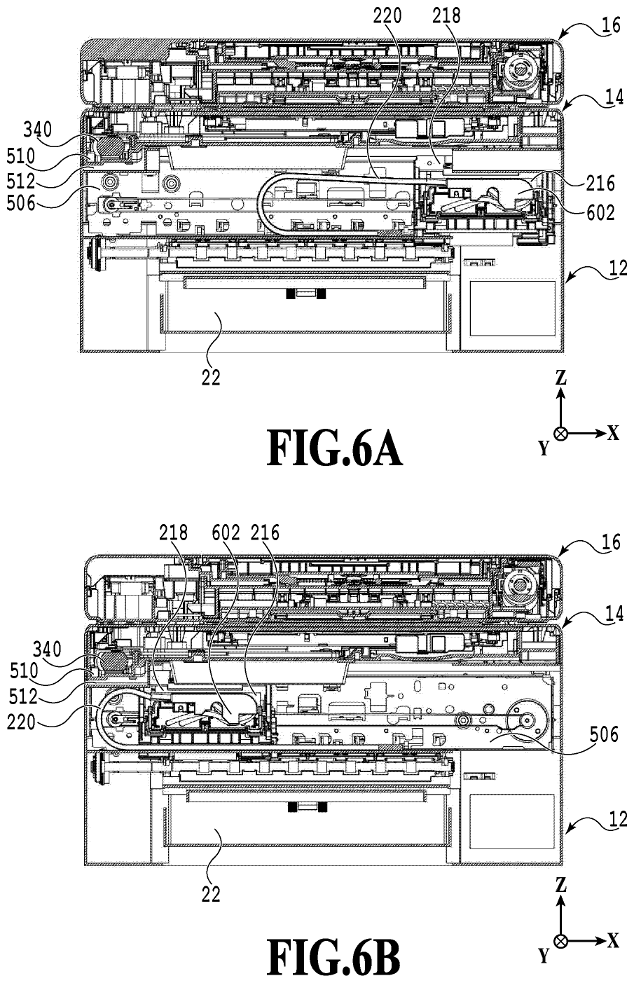

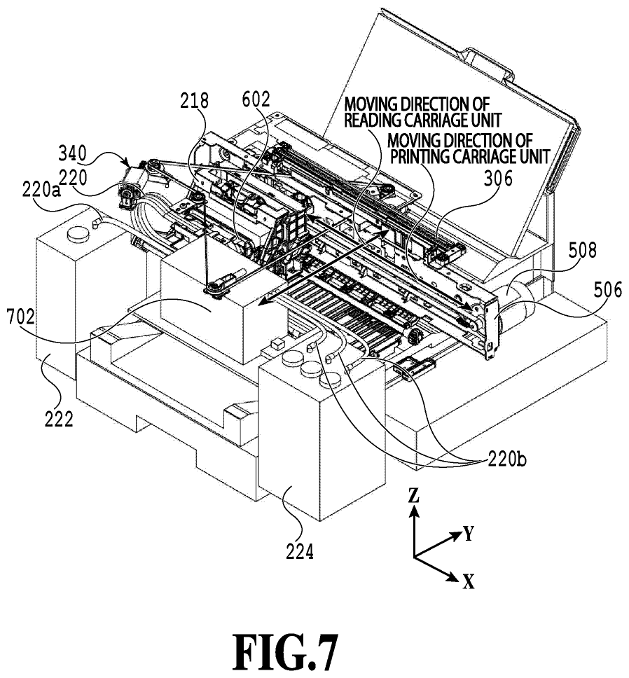

FIG. 6A and FIG. 6B are cross-sectional views taken along the line VI-VI in FIG. 1A. Further, FIG. 6A illustrates a state in which the printing carriage unit 218 is located at the right end of the movement area, and FIG. 6B illustrates a state in which the printing carriage unit 218 is located at the left end of the movement area. FIG. 7 is a diagram for explaining the positional relationship of the reading carriage unit 306, the drive motor 326, the printing carriage unit 218, and the ink tanks 222 and 224. In FIG. 7, configurations such as the housing portions of the image forming part 12 and the image reading part 14 are omitted for ease of understanding.

### <Configuration Around Printing Carriage Unit>

In the image forming part 12, during the printing operation, the sheets accommodated in the cassette 22 are fed in the direction of the arrow P1 (see FIG. 5A) by the pickup roller 202, and are conveyed to the printing area 500 via the conveyance path 210. In FIG. 5A, although illustration of the configurations arranged in the printing area 500 is omitted, the printing area 500 is an area where the printing carriage unit 218 moves and performs printing by ejecting ink onto a sheet. The printing area 500 includes the entire area where the print head 216, the printing carriage unit 218, the tube 220 for supplying ink, and the like move.

Further, the sheet placed on the manual feed tray 228 is transported in the direction of the arrow P2 by the ASF 502, and is conveyed to the printing area 500 via the conveyance path 232. The conveyance path 210 and the conveyance path 232 are arranged at positions overlapping in the X direction and the Y direction, and, on their upper side, the control circuit board 504 that functions as a control part that controls the overall operation of the image forming apparatus 10 is arranged. The control circuit board 504 is fixed to the chassis 506 extending in the X direction, and is connected to various electrical components installed in the image forming apparatus 10 via cables (not illustrated in the drawings).

The printing carriage unit 218 is arranged on the front side of the chassis 506, which is the opposite side of the control circuit board 504 (see FIG. 5B), and is guided and supported by the chassis 506 extending in the X direction, so as to be able to reciprocate in the X direction using the drive motor 508 as the driving source. The printing carriage unit 218 is connected to the control circuit board 504 via a flexible cable (not illustrated in the drawings), and print data that is output from the control circuit board 504 is input to the print head 216 via the flexible cable. The printing carriage unit 218 located at the left end of the movement area (see FIG. 6B) partially overlaps with the ink tank 222 in the X direction. Further, the printing carriage unit 218 located at the right end of the movement area (see FIG. 6A) partially overlaps with the ink tank 224 in the X direction.

### <Overview of Shape of Boundary>

The image forming part 12 and the image reading part 14 both have substantially rectangular parallelepiped shapes. Furthermore, in a state where the image reading part 14 is in a closed state on the image forming part 12, the bottom surface 14a of the image reading part 14 (see FIG. 14) is located above the upper surface 12a of the image forming part 12 (see FIG. 14) so as to face the upper surface 12a. The bottom surface 14a of the image reading part 14 has a substantially planar shape, but the shape has a part that protrudes downward. For example, the bottom surface 14a of the image reading part 14 has a shape that protrudes downward at the area where the drive unit 340 is located. That is, in the image reading part 14, the bottom surface 14a has a shape that protrudes downward at the accommodation part 510 that accommodates the drive unit 340. Therefore, the upper surface 12a of the image forming part 12 is formed with the reception part 512 which is a concave portion that can receive the downwardly-protruding shape of the bottom surface 14a at a position facing the accommodation part 510 in the state where the image reading part 14 is in the closed state. The shapes of the accommodation part 510 and the reception part 512 are described later.

In the present embodiment, in the image forming part 12, the right end of the movement area of the printing carriage unit 218 is the home position. Therefore, during the time not performing a printing operation or the time performing maintenance, etc., the printing carriage unit 218 is located at the right end of the movement area, which is the home position (see FIG. 6A). Note that, although illustration in the drawings is omitted, various members are installed at the home position for executing maintenance to maintain and recover favorable ink ejection from the print head 216.

On the other hand, at the time the printing carriage unit 218 is located at the left end of the movement area, the printing carriage unit 218 and the accommodation part 510 partially overlap in the X direction and the Z direction (see FIG. 6B). That is, at the left end of the movement area, the printing carriage unit 218 and the reception part 512 that receives the accommodation part 510 partially overlap in the X direction and the Z direction. However, the printing carriage unit 218 is formed so as not to come into contact with the reception part 512 that receives the accommodation part 510 (see FIG. 5B). That is, the printing carriage unit 218 is formed so as not to overlap with the reception part 512 in the Y direction. Accordingly, the printing carriage unit 218 and the reception part 512 are formed so as not to interfere with each other.

Note that the tube 220 is connected to the front side of the printing carriage unit 218 via the connecting part 602 (described later). That is, the arrangement positions of the connecting part 602 and the tube 220 overlap with the reception part 512 in the Y direction (see FIG. 5B). Therefore, at the time the printing carriage unit 218 is located at the left end of the movement area, there is a possibility that the tube 220 comes into contact with the reception part 512. However, since the tube 220 has flexibility, the movement operation of the printing carriage unit 218 is not inhibited by the tube 220 and the reception part 512 interfering with each other at the time the printing carriage unit 218 moves to the left end of the movement area. Further, since the connecting part 602 is arranged at a position that does not overlap with the reception part 512 in the height direction (the Z direction), the connecting part 602 does not interfere with the reception part 512.

The accommodation part 510 is located near the left end of the image forming apparatus 10 in order to accommodate the drive unit 340 arranged near the left end of the image reading part 14. Therefore, the reception part 512 that receives the accommodation part 510 also partially overlaps with the ink tank 222 in the X direction and the Z direction. However, as explained below, the ink tank 222 is formed so as not to come into contact with the accommodation part 510 in the Y direction. Accordingly, the ink tank 222 and the reception part 512 are formed so as not to interfere with each other.

As for the inks stored in the ink tanks 222 and 224, the respective types of ink used in the image forming part 12 are supplied to the print head 216 mounted on the printing carriage unit 218 via the tube 220. More specifically, the ink tank 222 that stores black ink is connected to the printing carriage unit 218 via the connecting part 602 attached to the printing carriage unit 218, the tube 220, and the valve unit 702 (see FIG. 7). The valve unit 702 is installed in the image forming part 12. The ink tank 222 is connected to the printing carriage unit 218 via one tube 220a, the valve unit 702, and the connecting part 602.

Further, the ink tank 224 that separately stores cyan ink, magenta ink, and yellow ink is also connected to the printing carriage unit 218 via the connecting part 602, the tube 220, and the valve unit 702. That is, the ink tank 224 is connected to the printing carriage unit 218 via three tubes 220b, the valve unit 702, and the connecting part 602. Note that the four tubes 220 are tied together between the valve unit 702 and the connecting part 602. Furthermore, the four tubes 220 are mounted between the printing carriage unit 218 and the ink tanks 222 and 224 in the Y direction so as to be movable in the X direction along with the reciprocal movement of the printing carriage unit 218.

### <Shape of Reception Part and Configuration of its Surrounding Members>

Herein, an explanation is given of the shape of the reception part 512 located between the ink tank 222 and the printing carriage unit 218 as well as on the movement area of the tube 220 (and the connecting part 602), and the arrangement of its surrounding members. Note that the reception part 512 is configured to receive the accommodation part 510. Therefore, the internal shape of the accommodation part 510 (that is, the shape inside the housing of the image reading part 14) may be any shape as long as it can accommodate the drive unit 340 and receive the reception part 512.

In the housing 320 of the image reading part 14, the above-mentioned reading carriage unit 306 and various configurations for making the reading carriage unit 306 movable in the Y direction, as well as a flat cable (not illustrated in the drawings) connected to the reading carriage unit 306, are accommodated. In such a configuration where components are accommodated in the housing 320, the thickness in the Z direction required to accommodate the members other than the drive motor 326 is smaller than the thickness in the Z direction required to accommodate the drive motor 326. Therefore, if the thickness of the housing 320 is uniformly defined according to the thickness of the drive motor 326, the image reading part 14 may be elongated in the Z direction, which incurs an increase in the size of the image forming apparatus 10.

Therefore, in the present embodiment, the overall thickness of the housing 320 is defined by the dimensions required for the arrangement of the members other than the drive motor 326, and then the thickness is thickened downwardly for the portion where the drive unit 340 including the drive motor 326 occupies. That is, the portion corresponding to the drive unit 340, that is, the accommodation part 510 that accommodates the drive unit 340, is formed so as to protrude toward the image forming part 12 in the state where the image reading part 14 is closed. Furthermore, in the image forming part 12, the reception part 512 that receives the accommodation part 510 is formed at a position corresponding to the accommodation part 510 that protrudes in the state where the image reading part 14 is closed.

In the image forming part 12, the space between the ink tank 222 and the printing carriage unit 218 in the Y direction above and near the left end of the movement area of the tube 220 is utilized for forming the reception part 512. As described above, above and near the left end of the movement area of the tube 220, due to the height position of the connecting part 602, the material of the tube 220, etc., the movement operation of the printing carriage unit 218 is not interfered by the reception part 512.

Hereinafter, an explanation is given of the shapes of the printing carriage unit 218 and the ink tank 222 located in the front-back direction of the space in which the reception part 512 is formed. To form the reception part 512, in the present embodiment, the upper side of the back surface 522 of the ink tank 222 is positioned closer to the front surface compared to the lower side thereof. Furthermore, the front portion of the printing carriage unit 218 is formed so that its back side is higher and its front side is lower.

Specifically, the front surface 512a of the reception part 512 (FIG. 5B) faces the upper area 522a of the back surface 522 of the ink tank 222 with spacing so as not to come into contact with each other. The back surface 522 of the ink tank 222 includes the upper area 522a, the lower area 522b located on the back side relative to the upper area 522a, and the connection area 522c connecting the upper area 522a and the lower area 522b. The upper area 522a and the lower area 522b are formed substantially parallel to the Z direction.

In this way, the size of the ink tank 222 in the Y direction (the length in the Y direction) is smaller on the upper side where the reception part 512 is formed. Further, the size in the Y direction is increased on the lower side where the reception part 512 is not formed, so that the lower side is positioned on the back side by the length Yf from the front surface 512a of the reception part 512 in the Y direction. That is, the ink tank 222 and the reception part 512 overlap by the length Yf in the Y direction. Accordingly, a decrease in the amount of ink that can be stored in the ink tank 222 is suppressed.

On the other hand, the back side of the reception part 512 is the inclined surface 512b that is inclined downwardly toward the front side (see FIG. 5B). In the front portion of the printing carriage unit 218, the front side thereof to which the connecting part 602 and the tube 220 are connected is formed lower than the back side thereof. Therefore, in accordance with the shape of the front portion of the printing carriage unit 218, the inclined surface 512b faces the front portion with spacing so as not to come into contact with each other. The overlapping length of the printing carriage unit 218 including the connecting part 602 and the reception part 512 in the Y direction is the length Yr. For example, in order to improve throughput, the printing carriage unit 218 and the drive motor 508 may be made larger. Even in such a case, if a low area where the connecting part 602 and the tube 220 are installed is formed on the front side of the printing carriage unit 218 by forming the inclined surface 512b as described above, the reception part 512 can be formed.

The space below the reception part 512 overlaps with the space in which the connecting part 602 and the tube 220 move along with the movement of the printing carriage unit 218. In the present embodiment, the tube 220 is made of a soft and flexible material such as silicone or thermoplastic (TPE), and, as illustrated in FIG. 6A and FIG. 6B, the tube 220 extends in the X direction while making a U-turn to draw an arc to the left. Furthermore, the tube 220 reciprocates in the X direction along with the printing carriage unit 218.

Therefore, at the time the printing carriage unit 218 is located on the right side, which is the home position side, the tube 220 and the connecting part 602 are not located below the reception part 512. On the other hand, if the printing carriage unit 218 moves to the left side, the connecting part 602 is located there together with the arc-shaped tube 220. The connecting part 602 is located at a lower position than the reception part 512 on the front side of the printing carriage unit 218. On the other hand, the arcuate portion of the tube 220 becomes higher as the tube 220 moves toward the left side, but the upward expansion of the arcuate portion is restricted by the bottom surface 512c of the reception part 512. At this time, since the tube 220 is made of a soft and flexible material, the arcuate portion of the tube 220 whose upward expansion is restricted will expand in directions other than the upward direction.

As described above, in the image reading part 14 of the present embodiment, the drive unit 340 which increases in size in the height direction is arranged at the position which is near the left end in the X direction and above the movement area of the tube 220 of the image forming part 12 in the Y direction and corresponds to the space between the printing carriage unit 218 and the ink tank 222. Accordingly, each configuration of the image forming part 12 and the image reading part 14 can be arranged without incurring an increase in cost of components, and, while implementing smooth movement of the printing carriage unit 218 and the reading carriage unit 306, an increase in size of the image forming apparatus 10 can be suppressed.

### (Configuration of ADF)

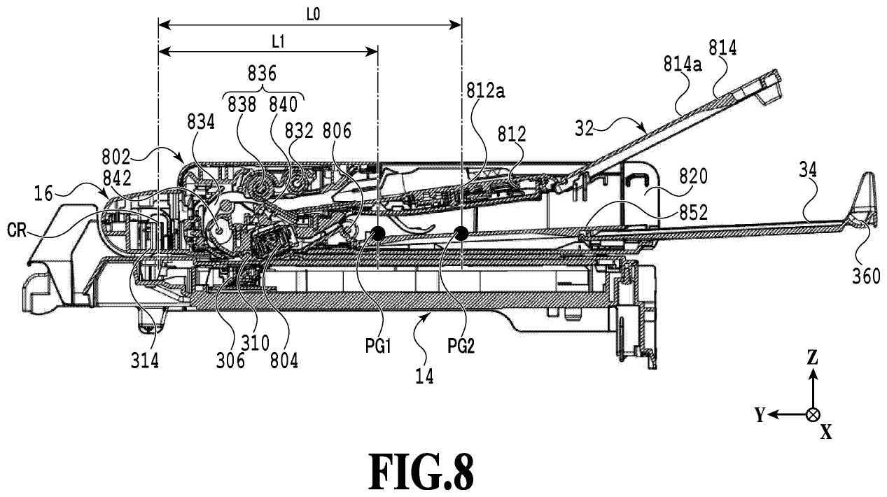

Next, an explanation is given of the configuration of the ADF 16. FIG. 8 is a cross-sectional view of the image reading part 14 and the ADF 16 at substantially the center position in the X direction. The ADF 16 includes the document feeding tray 32 on which a document to be read is placed, the document feeding part 802 that feeds the document placed on the document feeding tray 32, and the back-surface reading image sensor 804 capable of reading the back surface of the document to be fed. Further, the ADF 16 also includes the discharge roller 806 that discharges the fed document and the document discharge tray 34 on which the document discharged by the discharge roller is placed. Note that, via the ADF glass 310, the back-surface reading image sensor 804 is located on the downstream side in the feeding direction relative to the position where the image of one surface (the front surface) of the document to be fed is read as well as on the upstream side in the feeding direction relative to the discharge roller 806. The back-surface reading image sensor 804 is, for example, a contact image sensor (CIS) and reads the image of the other surface (the back surface) of the document to be fed from the document feeding part 802.

More specifically, the document feeding tray 32 is installed on the front side of the ADF 16, and at least a part thereof is configured to be slidable to the front side. Specifically, the document feeding tray 32 includes the main tray 812 equipped with the first support surface 812a that supports the document placed thereon and the sub-tray 814 equipped with the second support surface 814a that supports the document together with the first support surface 812a. The main tray 812 is, for example, fixedly installed on the housing 820, and is formed such that the first support surface 812a is inclined downwardly from the front side toward the back side. The sub-tray 814 is configured to be movable in a sliding manner between the first position (the position illustrated in FIG. 1A), which forms a part of the outer shape of the housing 820 of the ADF 16, and the second position, in which the placed document can be supported by the first support surface 812a and the second support surface 814a. Note that the second support surface 814a of the sub-tray 814 in the first position is exposed as an surface of the housing 820. The second position is located on the front side relative to the first position.

The document feeding part 802 includes the pickup roller 832 that picks up the uppermost document of multiple documents stacked on the document feeding tray 32 and the separation part 836 that separates the picked up documents one by one and conveys them to the conveyance path 834. The separation part 836 includes the separation roller 838 and the separating pad 840, and the separation roller 838 and the separating pad 840 work together to separate the picked up documents one by one.

The documents that have been picked up by the pickup roller 832 and separated one by one by the separation part 836 are fed from the front side toward the back side and transferred to the conveyance path 834. The conveyance path 834 is curved in a substantially U-shape, so that the documents transferred from the front side toward the back side change the direction of transfer from the back side to the front side. In the curved portion of the conveyance path 834, the conveyance roller 842 that can convey the documents is installed. Furthermore, as for a document which has been conveyed by the conveyance roller 842 and whose conveyance direction has been changed by the conveyance path 834 from the back side to the front side, the image of the front surface of the document is read at the position facing the ADF glass 310. Further, relative to that position in the conveyance path 834, the back-surface reading image sensor 804 is installed on the downstream side in the document conveyance direction, so that, at the time of reading the back surface of the document, the image of the back surface of the document is read at the position facing the back-surface reading image sensor 804.

The discharge roller 806 discharges the documents conveyed in the conveyance path 834 onto the discharged document support surface 852 and the document discharge tray 34. Due to the conveyance path 834, the direction in which the documents are discharged is from the back side toward the front side, which is the direction opposite to the direction of feeding by the pickup roller 832 and the like.

The document discharge tray 34 is installed so that it can be inserted and drawn out below the discharged document support surface 852 formed integrally with the housing 820 of the ADF 16. The document discharge tray 34 can be drawn out from the back side to the front side at the time of the inserted state, and can be inserted by being pressed from the front side to the back side at the time of the drawn out state. Therefore, by drawing out the document discharge tray 34, the support surface that can support the discharged documents is extended in the Y direction. The grip part 860 is formed at the front end of the document discharge tray 34 for the user to grasp at the times of inserting and drawing out the document discharge tray 34.

### (Document Feeding Tray)

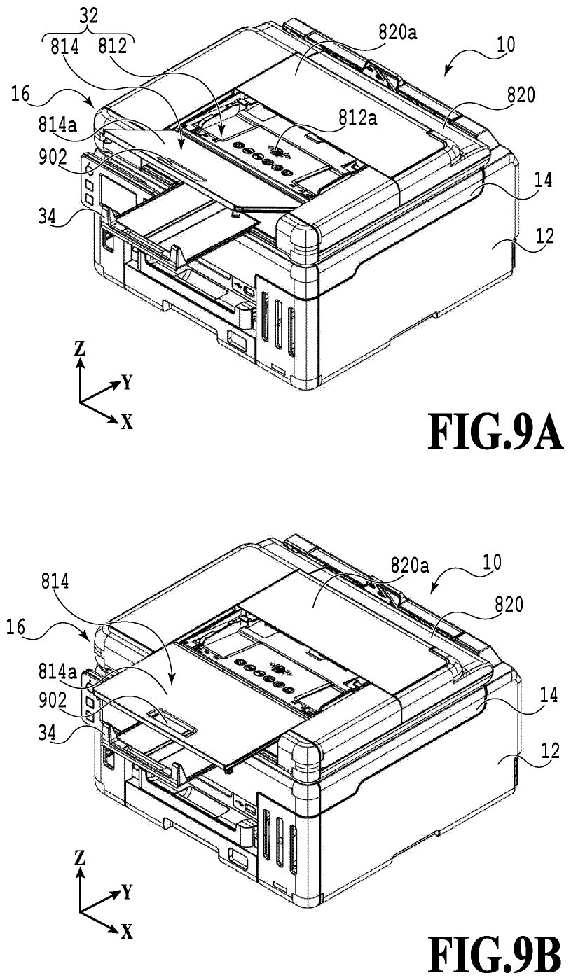

Next, with reference to FIG. 9A and FIG. 9B, an explanation is given of the document feeding tray 32. FIG. 9A and FIG. 9B are diagrams illustrating forms of the document feeding tray 32 in a case where a document is placed. FIG. 9A is a perspective view of the image forming apparatus 10 with the sub-tray 814 being in an inclined posture at the second position. FIG. 9B is a perspective view of the image forming apparatus 10 with the sub-tray 814 being in a horizontal posture at the second position.

In the document feeding tray 32, at the time the ADF 16 is not in use, the sub-tray 814 is located at the first position, and is in an accommodated state in which the sub-tray 814 forms an outer shape (an exterior surface) of the ADF 16 (see FIG. 1A). Furthermore, at the time the ADF 16 is in use, the sub-tray 814 is located at the second position, where the second support surface 814a of the sub-tray 814 and the first support surface 812a of the main tray 812 form a surface that supports documents, and documents are placed on the surface. At the second position, the sub-tray 814 can be brought into an inclined posture in which the second support surface 814a is inclined by pivotal movement of its leading edge upward at the second position where the sub-tray 814 is drawn out from the first position (see FIG. 9A). Further, the sub-tray 814 can be brought into a horizontal posture in which the second support surface 814a is substantially horizontal while remaining at the second position where the sub-tray 814 is drawn out from the first position. Furthermore, documents are placed on the document support surface formed by the second support surface 814a of the sub-tray 814, which is in the inclined posture or the horizontal posture at the second position, and the first support surface 812a of the main tray 812.

The second support surface 814a of the sub-tray 814 is exposed to the outside while being at the first position. Therefore, by simply drawing out the sub-tray 814 from the first position to the second position, or by simply lifting its leading edge thereafter, the second support surface 814a can form the support surface, on which documents can be placed, together with the first support surface 812a of the main tray 812.

At the time the sub-tray 814 is located at the first position, the second support surface 814a and the upper surface 820a of the housing 820 are flush with each other, or are continuous with almost no step. Note that the upper surface 820a and the second support surface 814a are designed to be substantially horizontal at the time the image forming apparatus 10 is installed. Therefore, documents or the like can be stably placed on the upper surface of the image forming apparatus 10, which is formed by the upper surface 820a and the second support surface 814a. At the time the sub-tray 814 is located at the second position in the inclined posture, the inclination angle of the first support surface 812a and the inclination angle of the second support surface 814a may be substantially the same, or, as in FIG. 8, the inclination angle of the second support surface 814a may be greater. Further, at the time the sub-tray 814 is located at the second position in the inclined posture, the first support surface 812a and the second support surface 814a may be continuous in the Y direction (see FIG. 8), or there may be a space between the first support surface 812a and the second support surface 814a.

Near the front end of the second support surface 814a, the sub-tray 814 includes the handle part 902 on which the user can put his or her hand for sliding the sub-tray 814. The handle part 902 is formed at a substantially central position in the X direction on the second support surface 814a, and has an opening with a predetermined width in the X direction so that the user can insert multiple fingers to put his or her hand. The sub-tray 814 is configured to be movable in a sliding manner in the front-back direction, and is configured to slide forward or backward if a certain force is applied in the front-back direction at the first position or the second position, for example. Therefore, the user can utilize the handle part 902 of the sub-tray 814 to open the ADF 16 by lifting the sub-tray 814 upward without sliding it. Accordingly, in order to open the ADF 16, the user can utilize not only the notch part 316 formed on the housing 820 of the ADF 16 (see FIG. 3A) but also the handle part 902, and thus the operability for the user is improved.

### (Document Discharge Tray)

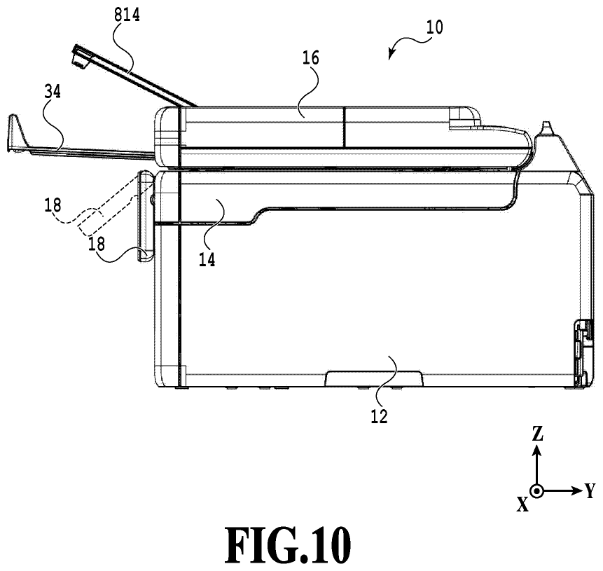

Next, with reference to FIG. 10, an explanation is given of the document discharge tray 34. FIG. 10 is a right side view of the image forming apparatus 10. As described above, the document discharge tray 34 is installed so that it can be inserted or drawn out below the discharged document support surface 852 formed integrally with the housing 820. Specifically, the moving direction of the document discharge tray 34 substantially matches the moving direction of the sub-tray 814 at the time of sliding to change its position from the first position to the second position. In the drawn out state, the document discharge tray 34 is located below the sub-tray 814 located at the second position.

The document discharge tray 34 is designed to be shorter than the document feeding tray 32 in the X direction (see FIG. 9B). In the ADF 16, the document discharge tray 34 is formed at a position that does not overlap in the X direction with the operation panel 18 installed near the front left end of the image forming apparatus 10 (see FIG. 1B). Accordingly, if the user views the image forming apparatus 10 from the front upper side, the document discharge tray 34 in the drawn out state does not overlap with the operation panel 18.

Here, the operation panel 18 is installed so as to be capable of pivotal movement within a predetermined range about a rotation axis parallel to the X direction. For example, within the predetermined range, the operation panel 18 can be set to a desired position in the pivotal movement (see FIG. 10). The predetermined range in which the pivotal movement of the operation panel 18 can be performed is, for example, a range in which, at the time of directly facing the image forming apparatus 10, the user can visually perceive what is displayed on the display part 44 and can operate the physical switch 42. Note that the position at which the operation panel 18 can be fixed may be changed in stages.

If the document discharge tray 34 is arranged at a position overlapping with the operation panel 18 in the X direction, the drawn out document discharge tray 34 covers a part of the operation panel 18 from above, resulting in deterioration in operability and visibility of the operation panel 18 for the user. In particular, the document discharge tray 34 is drawn out from the lower side of the ADF 16 arranged at an upper part of the image forming apparatus 10. For this reason, the distance between the document discharge tray 34 in the drawn out state and the operation panel 18 in the Z direction is short, and thus the operability and visibility of the operation panel 18 are significantly deteriorated.

In the present embodiment, the document discharge tray 34 is formed at a position that does not overlap with the operation panel 18 in the X direction, thereby suppressing the above-mentioned deterioration in the operability and visibility of the operation panel 18 for the user. Note that, in consideration of the size of the image forming apparatus 10, the size of the operation panel 18, etc., the document discharge tray 34 and the operation panel 18 may have a positional relationship overlapping with each other in the X direction. In this case, for example, the operability and visibility via the display part 44 may be ensured by at least avoiding overlapping with the display part 44.

Note that, in the present embodiment, the sub-tray 814 of the document feeding tray 32 located above the document discharge tray 34 is designed to be longer than the document discharge tray 34 in the X direction. Therefore, at the time the sub-tray 814 is at the second position, the sub-tray 814 covers a part of the operation panel 18 from above. However, since the sub-tray 814 is located above the document feeding tray 32 and has an inclined posture at the second position, its distance to the operation panel 18 in the Z direction is longer compared to the distance from the document discharge tray 34. Therefore, there is little influence on the operability and visibility of the operation panel 18 for the user. Therefore, in the present embodiment, by configuring the document discharge tray 34 and the sub-tray 814 of the document feeding tray 32 as described above, it is possible to suppress an increase in size of the image forming apparatus 10 and ensure the operability and visibility of the operation panel 18.

### (Document Conveyance Center in ADF)

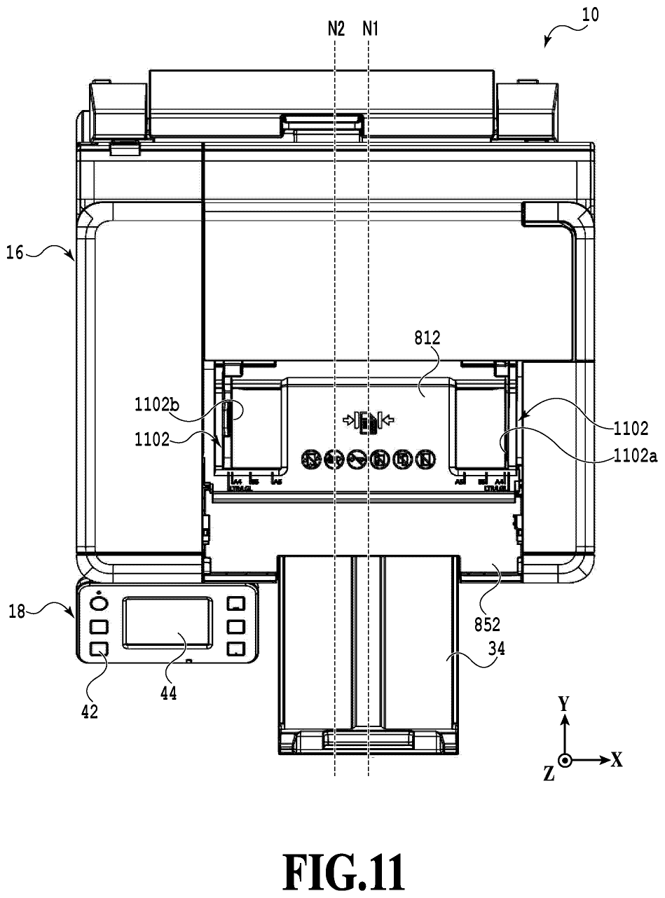

Next, with reference to FIG. 11, an explanation is given of the document conveyance center in the ADF 16. FIG. 11 is a diagram illustrating the document conveyance center in the ADF 16 and the center position of the image forming apparatus 10 in the X direction. Note that, in FIG. 11, illustration of the sub-tray 814 of the document feeding tray 32 is omitted for ease of understanding.

As illustrated in FIG. 11, in the X direction, the document conveyance center N1 in the ADF 16 is located on the right side of the center position N2 of the image forming apparatus 10. The document conveyance center N1 in the ADF 16 in the X direction is the center position of the document conveyance path from the document feeding part 802 to the discharge roller 806 in the X direction. The center position N2 of the image forming apparatus 10 in the X direction is defined as the center position between both end faces of the outer shape of the image forming apparatus 10 in the X direction. Hereinafter, “document conveyance center N1” is simply referred to as “conveyance center N1”, and “center position N2 of the image forming apparatus 10” is simply referred to as “center position N2”, as appropriate.

Here, in the present embodiment, the main tray 812 of the document feeding tray 32 is equipped with the pair of regulation guides 1102 for regulating both ends of a document placed thereon in the width direction (the X direction). Regarding the pair of regulation guides 1102, the opposing regulation surfaces 1102a and 1102b are movable toward and away from each other in the X direction according to the size of the document. Therefore, the center position of the placed document in the X direction is determined by the regulation surfaces 1102a and 1102b. Therefore, the center position between the regulation surfaces 1102a and 1102b of the regulation guides 1102 in the X direction, in other words, the center position of the document in the X direction after regulation by the regulation guides 1102, can be referred to as the document conveyance center N1. Note that, in the present embodiment, the center position of the document discharge tray 34 in the X direction substantially matches the document conveyance center N1.

Regarding the pair of regulation guides 1102 installed on the main tray 812, the regulation surface on one side may be fixed, and the regulation surface on the other side may be movable according to the size of placed documents. In this case, the position of the document conveyance center N1 in the X direction also shifts depending on the size of the documents. Therefore, in the case with such a configuration, the regulation guides are formed so that the document conveyance center N1 after regulation by the regulation guides is located on the right side of the center position N2 for all usable sizes of documents.

Although the document conveyance center N1 is located on the right side of the center position N2, there is not a limitation as such, and the document conveyance center N1 may be located on the left side of the center position N2. In the present embodiment, in consideration of the visibility and operability of the operation panel 18 during document conveyance, the conveyance center N1 is shifted to the right side, which is the side where the operation panel is not located in the X direction. That is, in the present embodiment, the document conveyance center N1 is arranged so as to be shifted to the opposite side of the operation panel 18 with respect to the center position N2 of the image forming apparatus 10 in the X direction.

Although the operation panel 18 is installed in the vicinity of the left end of the front surface of the image forming apparatus 10 in the present embodiment, there is not a limitation as such. That is, it is sufficient as long as the operation panel 18 is located on the left side or the right side of the center position N2 of the image forming apparatus 10. In other words, it is sufficient as long as the entire operation panel 18 is arranged off the center position N2 in the X direction. In this case, depending on the arrangement position of the operation panel 18, the arrangement positions of other configurations such as the document discharge tray 34 are determined in consideration of the visibility, operability, etc., of the operation panel 18. Further, the displacement amount of the document conveyance center N1 from the center position N2 of the image forming apparatus 10 may be small as far as the above-described relationship between the operation panel 18 and the document discharge tray 34 and sub-tray 814 is satisfied.

Since the conveyance center N1 is shifted from the center position N2 in the X direction, the ADF 16 has a larger area where documents do no pass on the opposite side of the side to which the conveyance center N1 is shifted from the center position N2 in the X direction. Therefore, motors (not illustrated in the drawings) and gears (not illustrated in the drawings) for driving each roller of the document feeding part 802 can be accommodated in the area where documents do not pass.

### (Functional Effect)

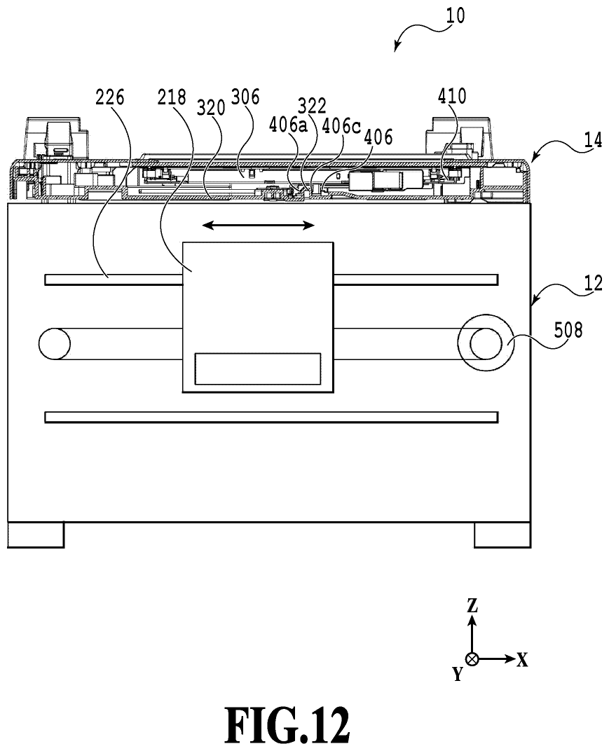

With reference to FIG. 12, an explanation is given of vibrations that occur at the time the printing carriage unit 218 moves. FIG. 12 is a diagram schematically illustrating the printing carriage unit 218, the reading carriage unit 306, their movement mechanisms, etc., in the image forming apparatus 10.

In the image reading part 14, in the fixed reading mode, the reading carriage unit 306 moves in the Y direction along the rail part 322 fixed to the housing 320 of the image reading part 14. On the other hand, in the image forming part 12, during printing, the printing carriage unit 218 moves in the X direction along the guide rail 226. Further, the reading carriage unit 306 is configured such that the sliding surfaces 406a and 406c installed on the slider 406 move at a constant speed while constantly contacting the rail part 322 due to the biasing force of the pressing spring 410.

Here, in an image forming apparatus based on a known technique in which the moving direction of a reading carriage unit matches the moving direction of a printing carriage unit, at the time reading of an image coincides with printing on a sheet, the movement speed of the reading carriage unit may become inconstant. For example, suppose that, while the reading carriage unit is moving in the X direction to read a document, the printing carriage unit is accelerated or decelerated in the X direction. In this case, such acceleration or deceleration of the printing carriage unit causes vibration in the X direction in the image forming apparatus 10, and this vibration causes the reading carriage unit to move at an uneven speed, which may result in improper reading of the document.

On the other hand, as described above, in the image forming apparatus 10 of the present embodiment, the reading carriage unit 306 and the printing carriage unit 218 are configured to move in directions orthogonal to each other. Further, the sliding surface of the slider 406 of the reading carriage unit 306 is biased against the rail part 322 by the pressing spring 410. Therefore, even if vibration occurs due to acceleration or deceleration at the time the printing carriage unit 218 moves, the vibration has little effect on the movement of the reading carriage unit 306 and has little effect on the reading function. That is, even if the above-described vibration occurs, the reading carriage unit 306 can move at a constant speed.

Further, even if the printing carriage unit 218 is configured to be movable at high speed in order to improve the printing speed, by increasing the biasing force of the pressing spring 410, it is possible to suppress the slider 406 from rattling on the rail part 322. Accordingly, it becomes possible to move the reading carriage unit 306 in a stable posture, and thus it becomes possible to both maintain the accuracy of image quality in reading and improve the productivity of printed products.

Further, as explained above, in the present embodiment, the moving direction of the print head 216 for printing on a sheet conveyed in the image forming part 12 intersects the moving direction of the image sensor 402 for reading the image of the document in the image reading part 14. Therefore, the document conveyance direction and discharge direction of the ADF 16 that automatically conveys documents to be read by the image sensor 402 in the image reading part 14 is the same as the discharge direction of printed sheets in the image forming part 12, i.e., the Y direction.

Accordingly, even if the image forming apparatus 10 is arranged in a narrow space so that printed sheets are discharged in front of the user, it is possible to place documents on the document feeding tray 32 and remove documents from the document discharge tray 34 in front of the user. Therefore, deterioration in user operability can be suppressed.

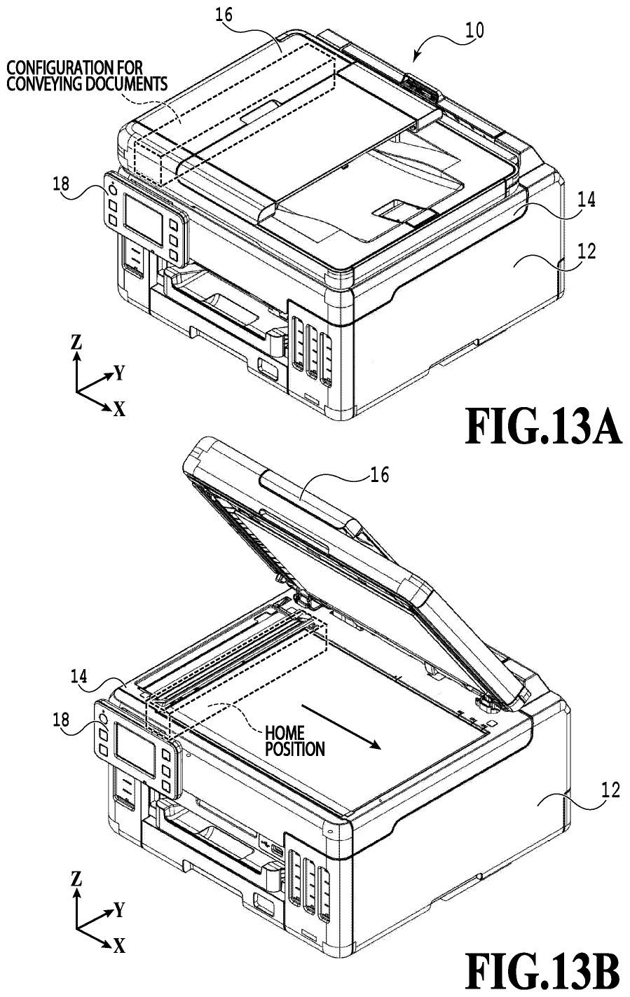

Further, in the present embodiment, the conveyance direction and discharge direction in the ADF 16 are the Y direction orthogonal to the X direction, which is the moving direction of the printing carriage unit 218 in the image forming part 12. Therefore, in the ADF 16, many of the configurations for conveying documents, such as the document feeding part 802, are located near the hinge parts 314, which have pivot axes for pivotal movement of the ADF 16 (see FIG. 8). On the other hand, in a comparative example in which the conveyance direction and discharge direction of an ADF are the X direction, which is the same as the moving direction of the printing carriage unit 218 in the image forming part 12, many of the configurations for conveying documents are located over the Y direction on one side of the X direction (see FIG. 13A). FIG. 13A is a diagram illustrating the positions where many of the configurations for conveying documents are arranged in an ADF according to a known technique as a comparative example.

Therefore, in the present embodiment, the center position of gravity PG1 of the ADF in the Y direction is located closer to the rotational center CR of the ADF than the center position of gravity PG2 of the ADF of the comparative example in the Y direction (see FIG. 8). Accordingly, in the present embodiment with the distance L1 from the rotational center CR to the center position of gravity PG1, the rotational moment about the pivot axes of the hinge parts with the own weight of the ADF is smaller than the rotational moment of the comparative example with the distance L0 from the rotational center CR to the center position of gravity PG2.

Here, the ADF 16 needs to maintain an opened state at a predetermined angle while the user places a document on the document table glass 308 (see FIG. 3A). For this reason, a spring (not illustrated in the drawings) and a cam (not illustrated in the drawings) are installed inside the hinge parts 314 of the ADF 16 as mechanisms for resisting the rotational moment about the pivot axes of the hinge parts 314 caused by their own weight to maintain the opened state. As described above, in the present embodiment, since the rotational moment about the pivot axes is smaller than that in the comparative example, it is possible to reduce the moments of the spring and cam that balance the rotational moment. Therefore, in the present embodiment, manufacturing costs can be suppressed compared to the comparative example.

Furthermore, the image reading part 14 needs to maintain an opened state (see FIG. 14A) during the time the user accesses the printing area 500 (see FIG. 5A) where the printing carriage unit 218 or the like is located. FIG. 14 is a diagram illustrating a state in which the image reading part 14 is opened. For that reason, the image forming apparatus 10 includes the support lever 1402 for maintaining the image reading part 14 in the opened state. One end of the support lever 1402 is supported by the image reading part 14 in a manner capable of pivotal movement. Furthermore, at the time the image reading part 14 is opened, the support lever 1402 pivotally moves so that the other end is locked by a lock mechanism (not illustrated in the drawings) installed in the image forming part 12.

At the time the image reading part 14 is closed, the lock of the other end of the support lever 1402 with the lock mechanism is released. Note that, since the ADF 16 is mounted on the upper part of the image reading part 14, the weight of the two units, i.e., the image reading part 14 and the ADF 16, is imposed on opening and closing of the image reading part 14. Therefore, in the image forming apparatus 10, if the lock of the support lever 1402 is released, the closing speed of the pivotally moving image reading part 14 increases due to its own weight, and there is a possibility that the user's hand or the like is caught. In order to suppress such concerns, the image forming apparatus 10 is equipped with a speed reduction mechanism. The speed reduction mechanism includes, for example, the fan gear 1404, a speed reduction gear train (not illustrated in the drawings), and an oil damper (not illustrated in the drawings). One end of the fan gear 1404 is fixed to the image reading part 14, and the last gear on the other end meshes with the reduction gear train that meshes with the oil damper installed in the image forming part 12.

At the time the image reading part 14 is brought into the opened state, the reading carriage unit 306 is located at the home position. Therefore, the center position of gravity of the image reading part 14 in the Y direction at this time is located on the back side where the home position is located, that is, on the rotational center side of the image reading part 14. On the other hand, in a comparative example with an image reading part based on a known technique, the unit including an image sensor is configured to move in the X direction, and thus the home position is located on one side in the X direction (see FIG. 13B). FIG. 13B is a diagram illustrating the home position of the comparative example of the image reading part based on a known technique. Therefore, the center position of gravity of the image reading part of the comparative example in the Y direction is located further away from the rotational center of the image reading part 14, compared to the center position of gravity of the image reading part 14 of the present embodiment in the Y direction.

Therefore, the rotational moment of the image reading part 14 with its own weight is smaller than the rotational moment of the comparative example caused by the own weight, and thus the moments of the reduction gear train and the oil damper that balance the rotational moment can be reduced. Accordingly, in the present embodiment, manufacturing costs can be suppressed, compared to the comparative example.

### Other Embodiments

Note that the above-described embodiment may be modified as shown in the following (1) through (5).

(1) Although the above-described embodiment includes the ADF 16 and has a function of reading a document conveyed by the ADF 16 with the image reading part 14, there is not a limitation as such. That is, the image forming apparatus 10 may not include the ADF 16, and the image reading part 14 may only have the function as a flatbed scanner.

(2) Although not particularly described in the above embodiment, the configuration that moves following the movement of the printing carriage unit 218 is not limited to the tube 220. For example, a flexible cable that electrically connects the printing carriage unit 218 and the control circuit board 504 may be installed so as to follow the movement of the printing carriage unit 218.

(3) Although the image forming part 12 performs printing by ejecting ink using an inkjet method in the above-described embodiment, there is not a limitation as such. As the printing method in the image forming part 12, various known printing methods may be used. That is, the technique according to the present disclosure can be applied to any configuration as long as a drive unit that moves a sensor at the time of reading an image is located on above a printing mechanism equipped with a carriage that moves with a print head mounted thereon and a flexible member that moves following the carriage inside the apparatus.

(4) Although only one pressing spring 410 is installed between the image sensor 402 and the sensor holder 404 in the vicinity of an end of the extending direction of the reading carriage unit 306 in the above-described embodiment, there is not a limitation as such. The pressing spring 410 may be installed at a position other than the vicinity of the end, and multiple pressing springs 410 may be installed.

(5) The above-described embodiment and various forms shown in (1) through (4) may be combined as appropriate.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-046750, filed Mar. 23, 2023, which is hereby incorporated by reference wherein in its entirety.

What is claimed is:

1. An image forming apparatus comprising:
a reading part configured with an image sensor capable of reading an image of a placed document while moving in a first direction with respect to the document; and
an image forming part configured with a print head that forms an image on a sheet conveyed in the first direction while moving in a second direction intersecting the first direction, based on input data or data read by the reading part.

2. The image forming apparatus according to claim 1,
wherein the reading part is arranged in a manner capable of pivotal movement on one side of the first direction with respect to the image forming part, and
wherein the image sensor is positioned on the one side of the first direction at the time reading is not performed.

3. The image forming apparatus according to claim 1 further comprising
a conveyance unit configured to convey the document to be read by the reading part,
wherein the reading part reads the image of the document conveyed by the conveyance unit in a state where the image sensor is positioned at a predetermined position in its movement area,
wherein a direction in which the document is conveyed by the conveyance unit is a direction from the one side toward the other side in the first direction, and
wherein a direction in which the document is discharged by the conveyance unit is a direction from the other side toward the one side in the first direction, and matches a direction for discharging a sheet on which an image has been formed by the image forming part.

4. The image forming apparatus according to claim 3,
wherein the conveyance unit is arranged in a manner capable of pivotal movement on the other side of the first direction with respect to the reading part.

5. The image forming apparatus according to claim 4,
wherein, on a document table where the document whose image is to be read by the image sensor is positioned, the reading part is equipped with
a first reading area where the document is placed on one surface and the image sensor moves on the other surface for reading the image of the document and
a second reading area where the document conveyed by the conveyance unit passes on one surface and the image sensor remains on the other surface for reading the image of the document,
wherein the second reading area is located on the other side of the first direction relative to the first reading area, and
wherein the image sensor is positioned between the first reading area and the second reading area at the time reading is not performed.

6. The image forming apparatus according to claim 3 further comprising:
a first tray on which the document to be conveyed is placed;
a second tray which is arranged on a lower side of the first tray in a manner capable of being inserted to or drawn out from a housing and on which a discharged document is to be placed; and
an operation unit which is arranged on a side surface of the reading part on the one side of the first direction and configured to be capable of operating the image forming apparatus,
wherein the operation unit does not overlap with the second tray in the second direction.

7. The image forming apparatus according to claim 6,
wherein the first tray includes a main tray fixedly installed on the housing and a sub-tray installed on the housing so as to be movable in a sliding manner, and
wherein the sub-tray changes its position between a first position in which a part of an exterior shape of the housing is formed and a second position in which a surface that forms the part of the exterior shape of the housing, together with the main tray, forms a support surface that supports the placed document.

8. The image forming apparatus according to claim 7,
wherein, at the second position, the sub-tray can be brought into
a first posture in which the surface that forms the part of the exterior shape of the housing is in a horizontal state and
a second posture in which the surface that forms the part of the exterior shape of the housing is inclined downwardly from the one side toward the other side in the first direction.

9. The image forming apparatus according to claim 7,
wherein a length of the sub-tray in the second direction is shorter than the second tray.

10. The image forming apparatus according to claim 3,
wherein a document conveyance center of the conveyance unit is located on one side of the second direction relative to a center position of the image forming apparatus, and
wherein, in the reading part, a driving part that serves as a driving source for moving the image sensor is located outside the movement area of the image sensor as well as on the other side of the second direction relative to the center position.

11. The image forming apparatus according to claim 10,
wherein the driving part is located near an end of the other side of the second direction.

12. The image forming apparatus according to claim 10,
wherein, of a bottom surface of the reading part facing the image forming part, a position corresponding to an accommodation part that accommodates the driving part is formed in a protruding manner.

13. The image forming apparatus according to claim 12,
wherein the image forming part includes
a reception part formed as an upper surface facing the bottom surface of the reading part, so as to receive a shape protruding for the accommodation part at the bottom surface, and
a storage part arranged on the one side of the first direction to store a printing agent to be supplied to the print head, and
wherein the reception part is located between the storage part and the print head in the first direction.

14. The image forming apparatus according to claim 13,
wherein, as for a surface of the storage part facing the print head in the first direction, its upper area near the reception part is located on the one side of the first direction relative to its lower area.

15. The image forming apparatus according to claim 13,
wherein a tube for supplying the printing agent is connected to a side of the print head facing the storage part in the first direction, and
wherein the tube is arranged so as to be movable along with movement of the print head within an area including a lower part of the reception part between the print head and the storage part.

16. The image forming apparatus according to claim 15,
wherein the tube is formed of a material that has flexibility.

17. The image forming apparatus according to claim 13,
wherein the one side of the first direction in an upper part of the print head is formed so as to be inclined downwardly from the other side toward the one side of the first direction, and
wherein a surface of the reception part facing the upper part is inclined in accordance with the inclination of the upper part.

18. The image forming apparatus according to claim 1,
wherein the image sensor extends in the second direction.

19. The image forming apparatus according to claim 1,
wherein the reading part is further configured with a driving part that serves as a driving source for moving the image sensor, a transmission part that transmits a driving force generated by the driving part to the image sensor, and a guide part that guides the image sensor which moves in accordance with the driving force transmitted by the transmission part, and
wherein the image sensor is configured with
a sliding part that is capable of sliding on the guide part which extends in the first direction and
a pressing part that presses the sliding part against the guide part.
